(19) United States
(12) Patent Application Publication
(10) Pub. No.: US 2021/0251263 A1
(43) Pub. Date: Aug. 19, 2021

(54) INTELLIGENT COOKING ASSISTANT

(71) Applicant: Cooksy Corporation, Tucson, AZ (US)

(72) Inventors: Jeffery Forbes KNIGHTON, Vail, AZ (US); Seth MARKS, Benson, AZ (US)

(21) Appl. No.: 16/941,399

(22) Filed: Jul. 28, 2020

Related U.S. Application Data
(60) Provisional application No. 62/976,818, filed on Feb. 14, 2020.

(51) Int. Cl. A23L 5/10; G06N 20/00; G06F 16/901; G06F 16/9035

(52) U.S. Cl. CPC A23L 5/10; G06F 16/9035; G06F 16/9024; G06N 20/00

(57) ABSTRACT

A computer system for providing interactive cooking experiences. The computer system includes a sensory array, and uses the sensory array to collect sensor data associated with a thermal property of a food preparation surface and/or an object on the food preparation surface as observed by a thermal sensor, and/or a visual property of the food preparation surface and/or the object as observed by a visible light sensor. Based on the collected sensor data, the computer system determines a temperature, an identity and/or a physical property of the food preparation surface and/or the object. The computer system determines a time attribute associated with the food preparation surface and/or the object. Based on the determining, the computer system initiates at least one of (i) progressing to a presentation of an existing instructional recipe step at a user output device; or (ii) generating a new instructional recipe step.

### CROSS-REFERENCE TO RELATED APPLICATIONS

This application claims priority to, and the benefit of, U.S. Provisional Patent Application Ser. No. 62/976,818, filed Feb. 14, 2020, entitled “INTELLIGENT COOKING ASSISTANT,” the entire contents of which are incorporated by reference herein in their entirety.

### BACKGROUND

In cooking, a recipe is the collection of instructive steps by which successful cooking sessions are recorded for future food reproduction. These recipes are difficult to create, and are often lacking in important details due to reliance on low resolution, and even subjective, textual terms to describe the activity to perform (e.g., sauté, stir, brown, etc.), as well as the time and temperature involved in the activity (e.g., medium-high heat, cook until translucent, until firm in the middle, etc.). Recipes can, therefore, be quite difficult to follow or recreate in a way that accurately represents the creator's intent.

Often, a recipe lacks significant and meaningful information that is required in order to reproduce the recipe. A recipe may call for “sauté over medium heat until golden brown.” But what is meant by medium heat? When does the mixture reach “golden brown?” A professional chef with significant experience may intuitively understand the answers to these questions, but a so-called “home” chef may not. As a consequence, the finished “home” version of the product may be less than anticipated.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to systems, devices, and methods for providing an intelligent cooking assistant. Some embodiments provide a food preparation surface accessory device for use within a cooking environment. The accessory device is used in connection with a food preparation surface (e.g., cooktop, grill, griddle, cutting board, food preparation area, etc.) includes a variety of sensor hardware, such as visible light and/or thermal sensors, that monitor the food preparation surface and collect sensor data relating to food preparation (e.g., cutting, chopping, mixing, stirring, blending, cooking, frying, etc.). In embodiments, the accessory device is part of a computing environment that utilizes the accessory device to record a “freestyle” recipe creation session, including recording time, temperature, ingredient, a video recording, and other recipe-related data. In additional, or alternative, embodiments, the accessory device is part of a computing environment that utilizes the accessory device to guide a user through accurately reproducing existing recipe steps (e.g., as recorded during a prior recipe creation session). In some embodiments the accessory device is integrated into a computer system that includes one or more user output devices, such as display, audio, and the like. In other embodiments, the accessory device is a standalone device that operates in communication with another general-purpose computer system that includes one or more user output devices, such as a smartphone, a tablet, or similar. Some embodiments provide a virtual “cooking assistant” that interacts with a chef user in real-time via one or more of audio prompts, visual display, touch interactions, and the like, for one or more of recipe creation or recipe reproduction. Some embodiments provide a cooking assistance service (e.g., cloud service) that provides a cooking dashboard comprising a library of recipes—including user-created recipes recorded during freestyle recipe creation session—social media features, and the like.

One or more embodiments are directed to methods, systems, and computer program products for providing interactive cooking experiences, and are implemented at a computer system that includes one or more processors and a sensory array. The computer system is configured to use the sensory array to collect sensor data associated with at least one of, (i) a thermal property of at least one of a food preparation surface or an object on the food preparation surface as observed by at least one thermal sensor, or (ii) a visual property of at least one of the food preparation surface or the object by at least one visible light sensor. The computer system is also configured to, based on the collected sensor data, determine at least one of (i) a temperature of at least one of the food preparation surface or the object (based at least on the thermal property), or (ii) at least one of an identity of or a physical property of the food preparation surface or the object (based at least on the visual property). The computer system is also configured to determine a time attribute associated with at least one of the food preparation surface or the object. The computer system is also configured to, based on the determining, initiate at least one of (i) progressing to a presentation of an existing instructional recipe step at a user output device based on at least one of the determined temperature, identity, or physical property of the food preparation surface or of the object, and further based on the determined time attribute; or (ii) generating a new instructional recipe step, the new instructional recipe step being based on at least one of the determined temperature, identity, or physical property of the food preparation surface or of the object, and further based on the determined time attribute.

One or more additional, or alternative, embodiments are directed to methods, systems, and computer program products for providing interactive cooking experiences, and are implemented at a computer system that includes one or more processors, one or more communications devices, and a user output device. Based on communicating with an accessory device over the one or more communications devices, the computer system determines at least one of a temperature, an identity, or a physical property of a food preparation surface or of an object on the food preparation surface. The determined temperature, identity, or physical property of the food preparation surface or of the object is determined based at least on sensor data collected by the accessory device that is associated with at least one of, (i) a thermal property of at least one of the food preparation surface or the object as observed by at least one thermal sensor, or (ii) a visual property of at least one of the food preparation surface or the object as observed by at least one visible light sensor. The computer system is also configured to determine a time attribute associated with at least one of the food preparation surface or the object. Based on the determining, the computer system performs at least one of (i) progressing to a presentation of an existing instructional recipe step at the user output device based on at least one of the determined temperature, identity, or physical property of the food preparation surface or of the object, and further based on the determined time attribute; or (ii) generating a new instructional recipe step, the new instructional recipe step being based on at least one of the determined temperature, identity, or physical property of the food preparation surface or of the object, and further based on the determined time attribute.

One or more additional, or alternative, embodiments are directed to a food preparation surface accessory device for providing interactive cooking experiences. The accessory device includes one or more processors, one or more communication devices, and a sensory array. The accessory device is configured to use the sensory array to collect sensor data associated with at least one of, (i) a thermal property of at least one of a food preparation surface or an object on the food preparation surface as observed by at least one thermal sensor, or (ii) a visual property of at least one of the food preparation surface or the object as observed by at least one visible light sensor. The accessory device is also configured to, based on the collected sensor data, determine at least one of (i) a temperature of at least one of the food preparation surface or the object (based at least on the thermal property), or (ii) at least one of an identity or a physical property of at least one of the food preparation surface or the object (based at least on the visual property). The accessory device is also configured to use the one or more communication devices to send at least one of the determined temperature, identity, or physical property of the food preparation surface or of the object to at least one of a network-accessible interactive cooking assistance service or a user interface (UI) computing device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example environment that includes an intelligent cooking assistant;

FIG. 2 illustrates an example architecture for implementing the intelligent cooking assistant;

FIG. 3 illustrates a flowchart of an example method for providing interactive cooking experiences;

FIGS. 4A-4D illustrate example user interfaces that may be presented as part of a “freestyle” augmented reality (AR) recipe creation session;

FIGS. 4E and 4F illustrate example user interfaces that may be presented as part of recipe selection;

FIGS. 4G and 4H illustrates example user interfaces that may be presented as part of a “scripted” AR recipe instruction session; and

FIG. 5 illustrates an example computer system capable of implementing any of the disclosed operations.

### DETAILED DESCRIPTION

At least some embodiments described herein relate to systems, devices, and methods for providing an intelligent cooking assistant. Some embodiments provide a food preparation surface accessory device for use within a cooking environment. The accessory device is used in connection with a food preparation surface (e.g., cooktop, grill, griddle, cutting board, food preparation area, etc.) includes a variety of sensor hardware, such as visible light and/or thermal sensors, that monitor the food preparation surface and collect sensor data relating to food preparation (e.g., cutting, chopping, mixing, stirring, blending, cooking, frying, etc.). In embodiments, the accessory device is part of a computing environment that utilizes the accessory device to record a “freestyle” recipe creation session, including recording time, temperature, ingredient, a video recording, and other recipe-related data. In additional, or alternative, embodiments, the accessory device is part of a computing environment that utilizes the accessory device to guide a user through accurately reproducing existing recipe steps (e.g., as recorded during a prior recipe creation session). In some embodiments the accessory device is integrated into a computer system that includes one or more user output devices, such as display, audio, and the like. In other embodiments, the accessory device is a standalone device that operates in communication with another general-purpose computer system that includes one or more user output devices, such as a smartphone, a tablet, or similar. Some embodiments provide a virtual “cooking assistant” that interacts with a chef user in real-time via one or more of audio prompts, visual display, touch interactions, and the like, for one or more of recipe creation or recipe reproduction. Some embodiments provide a cooking assistance service (e.g., cloud service) that provides a cooking dashboard comprising a library of recipes—including user-created recipes recorded during freestyle recipe creation session—social media features, and the like.

### Examples of Technical Benefits, Improvements, and Practical Applications

The following section briefly outlines some example improvements and practical applications provided by the disclosed embodiments. It will be appreciated, however, that these are just examples only and that the embodiments described herein are not limited to only these improvements.

The embodiments disclosed herein effectively enable the creation and use of a “High Definition” recipe, which is a recipe that contains, for example, detailed surface temperature data, timing data, video footage of performance of a recipe step, and other relevant/useful information for accurately reproducing the steps in a recipe—including, for example, notes on preparation or cooking techniques, or details on the equipment required. In contrast to the benefits provided by the disclosed embodiments, most current written recipes are “Low Definition,” meaning that they lack temperature and timing data with sufficient specificity in order to accurately reproduce food preparation sessions, and lack robust instructional information such as contextually-appropriate video footage.

For example, a traditional written recipe might include the step “sauté over medium heat until golden brown.” This step does not provide any clear information over what “medium” heat is, or how long it might take before the item becomes “golden brown.” A “High Definition” version of the same step in accordance with the embodiments described herein, on the other hand, includes temperature and time information, such as “sauté at 300 degrees for 8 minutes and 20 seconds.” Additionally, in embodiments, the disclosed cooking systems automatically adjust recipe instructions to compensate for detected variances in heat control, detected variances in elevation and other climate factors, detected variances in appliance characteristics. In some embodiments, the disclosed cooking systems automatically adjust timing aspects in real time. For example, if a user's cooktop, grill, griddle, etc. is detected to be set at 350 degrees instead of 300 (as specified in a recipe), the disclosed cooking systems may inform the user to only cook an item for 7 minutes and 30 seconds, instead of 8 minutes and 20 seconds as specified in the recipe.

Another way to understand the benefits of the disclosed embodiments is to liken existing written recipes to conventional printed hardcopy road atlas books. In contrast to the rudimentary navigation instructions provided by these books, the disclosed cooking systems is likened to a detailed GPS-based turn-by-turn navigation system available today in modern smartphones.

### Intelligent Cooking Assistant Overview

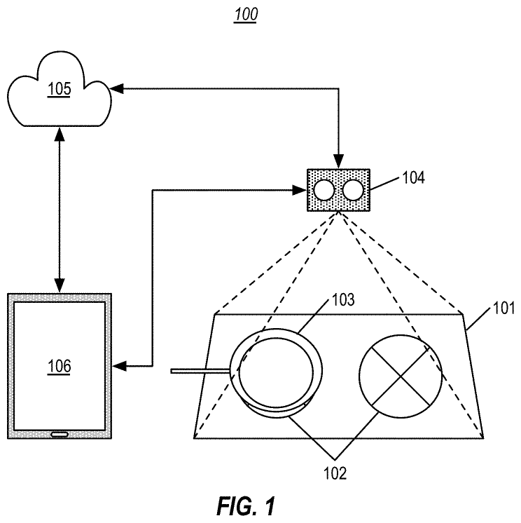

FIG. 1 illustrates an example environment 100 that incorporates an intelligent cooking assistant. In particular, FIG. 1 illustrates a food preparation surface 101 that includes one or more cooking elements 102. While the food preparation surface 101 in FIG. 1 is shown as being a cooktop, as used in this description, and in the claims, the term “food preparation surface” can be broadly construed to include any type of surface used for the preparation and/or cooking of food. Thus, in some embodiments, a food preparation surface comprises a cooking surface (e.g., such as a cooktop, grill, griddle, etc.). In other embodiments, however, a food preparation surface comprises a cutting board, a tabletop, or any other surface used for food preparation, even if that surface is not used for actual cooking.

As shown, environment 100 includes a food preparation surface accessory device 104 that is positioned proximate to the food preparation surface 101. As indicated by broken lines, the accessory device 104 is positioned such that one or more sensors of the accessory device 104 have a view of at least a portion of the food preparation surface 101, including at least one of the cooking elements 102. In various embodiments, the accessory device 104 is positioned within an existing hood, on a back wall, on a mobile stand that is mounted proximate to the food preparation surface 101, etc. In embodiments, the accessory device 104 uses one or more sensors to monitor the conditions of the food preparation surface 101, including any additional hardware (e.g., cookware 103) or mixtures (e.g., food) placed on top of the food preparation surface 101. In embodiments, sensors within the accessory device 104 includes any number of visible light cameras, thermal temperature cameras (e.g., infrared), barometers, humidity sensors, gas sensors, microphones, speakers, and the like.

As indicated by an arrow, in embodiments the accessory device 104 is enabled to communicate with a UI computing device 106 (e.g., tablet, smartphone, etc.). In some embodiments the accessory device 104 and the UI computing device 106 communicate wirelessly. In other embodiments accessory device 104 is tethered to the UI computing device 106 via a data cable (which, in embodiments, may also supply power to the accessory device 104). In some embodiments, the UI computing device 106 is not actually a separate device, but rather is integrated with the accessory device 104 to form a so-called “smart” hood capable of performing the combined operations of the accessory device 104 and the UI computing device 106.

As also indicated by arrows, in embodiments the UI computing device 106 and/or the accessory device 104 are able to communicate with a cloud service 105 (e.g., as cooking assistance service), which will be described in more detail infra.

### Intelligent Cooking Assistant Architecture

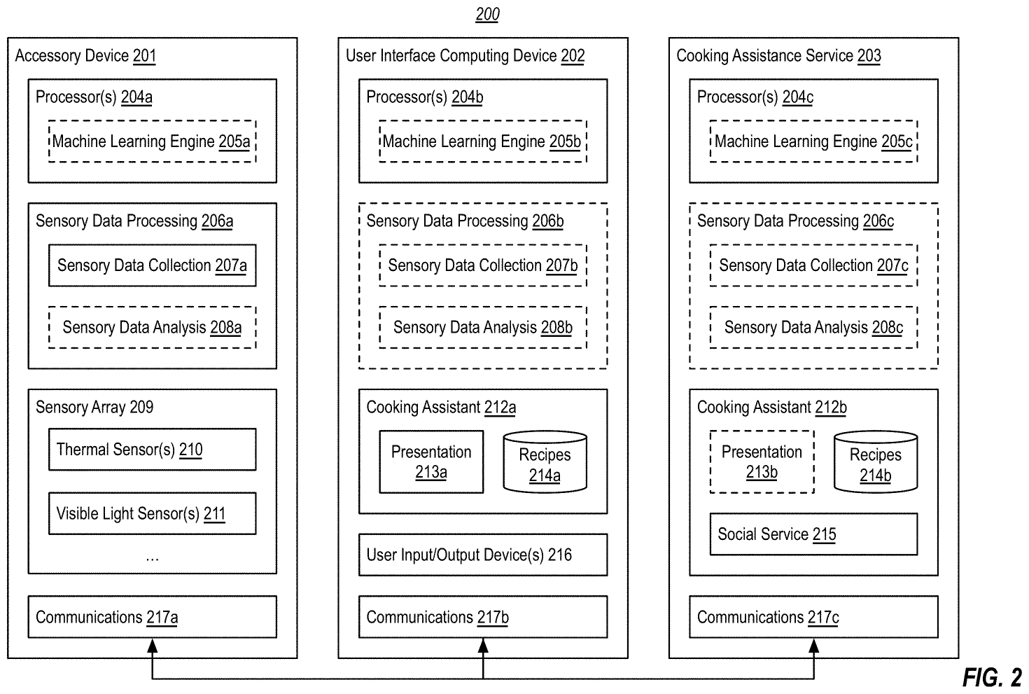

Attention is now directed to FIG. 2, which illustrates an example intelligent cooking assistant architecture 200. In embodiments, the intelligent cooking assistant architecture 200 is configured or structured to implement one or more of a food preparation surface accessory device 201 (which is representative of the accessory device 104 in FIG. 1), a UI computing device 202 (which is representative of the UI computing device 106 in FIG. 1), and/or a cooking assistance service 203 (which is representative of the cloud service 105 in FIG. 1), which singly or together implement functionality of an intelligent cooking assistant.

As shown, each of the accessory device 201, the UI computing device 202, and the cooking assistance service 203 includes processors 204 (i.e., processor(s) 204a at the accessory device 201, processor(s) 204b at the UI computing device 202, and processor(s) 204c at the cooking assistance service 203). In embodiments, one or more of these processors 204 are configured to include at least one processor configured as part of one or more machine learning (ML) engines 205 (i.e., ML engine 205a at the accessory device 201, ML engine 205b at the UI computing device 202, and/or ML engine 205c at the cooking assistance service 203). Additionally, each of the accessory device 201, the UI computing device 202, and the cooking assistance service 203 includes corresponding communications components 217 (i.e., communications component 217a at the accessory device 201, communications component 217b at the UI computing device 202, and communications component 217c at the cooking assistance service 203), which are indicated by arrows to be enabled for communications with each other. In various embodiments, communications components 217 include one or more wireless communications interfaces (e.g., wireless fidelity (Wi-Fi), Bluetooth, near-field communications (NFC), or cellular—such as 3G, 4G, or 5G, and the like) and/or one or more wired communications interfaces (e.g., ethernet, universal serial bus (USB), thunderbolt, a local bus, and the like).

In embodiments, the accessory device 201 is structured to collect or sense any amount of sensing data related to a food preparation surface, and/or objects associated therewith. Thus, the accessory device 201 is depicted as including a sensory data processing component 206a, which includes a sensory data collection component 207a, and a sensory array 209. In some embodiments, the sensory data processing component 206a uses the communications component 217a to send data sensed by sensory array 209, and collected by the sensory data collection component 207a, to one or both of the UI computing device 202 or cooking assistance service 203. Thus, each of the UI computing device 202 and cooking assistance service 203 are depicted as potentially including corresponding sensory data processing components 206 (i.e., sensory data processing component 206b at the UI computing device 202, and sensory data processing component 206c at the cooking assistance service 203), including corresponding sensory data collection components 207 (i.e., sensory data collection component 207b at the UI computing device 202, and sensory data collection component 207c at the cooking assistance service 203) configured to collect sensory data received from the accessory device 201.

In some embodiments the sensory array 209 is physically integral to (e.g., integrated into a housing of) the accessory device 201, while in other embodiments the sensory array 209 is physically separated/separable from the accessory device 201. In these latter embodiments, the sensory array 209 is attached to and/or in communications with other components of the accessory device 201 via wired and/or wireless communications (e.g., utilizing the communications component 217a). Thus, as used herein, references to the accessory device 201 “including” or “comprising” the sensory array 209 can include embodiments in which the sensory array 209 is physically distinct and separate from a housing of the accessory device 201. In embodiments, sensory array 209 includes additional processor(s) and/or communications device(s) for obtaining and transmitting sensor data to other components of the accessory device 201, such as to the sensory data processing component 206a.

In embodiments, the sensory data processing component 206a includes a corresponding sensory data analysis component 208a, which enables the accessory device 201 to perform one or more types of analysis (e.g., in conjunction with ML engine 205a) on sensory data in order to, for example, determine one or more properties of a food preparation surface, and/or objects associated therewith (e.g., using an object detection algorithm and/or artificial intelligence model). Additionally, or alternatively, this analysis could be performed by a sensory data analysis component 208b at the UI computing device 202 (e.g., in conjunction with the ML engine 205b) and/or by a sensory data analysis component 208c at the cooking assistance service 203 (e.g., in conjunction with the ML engine 205c).

In embodiments, the intelligent cooking assistant architecture 200 includes at least two “local” hardware devices, including the accessory device 201 and the UI computing device 202 (e.g., a tablet, laptop, desktop, smartphone, PDA, etc.). In these embodiments, the UI computing device 202 functions as the primary user interface device, acting on data received from the accessory device 201. In other embodiments, the intelligent cooking assistant architecture 200 includes a single local hardware device that incorporates both the accessory device 201 and the UI computing device 202. In either embodiment, the local hardware device(s) may communicate with the cooking assistance service 203, which aggregates information from multiple users, and in some embodiments provides an on-line social media community to share recipes.

In embodiments, the cooking assistance service 203 stores recipes and provides the opportunity to share them with other users. In embodiments, cooking assistance service 203 provides for the management of user account information as stored recipes. By way of example, the cooking assistance service 203 may enable user accounts to be created, removed, and modified; allow for recipes to be uploaded, added, or downloaded; allow for recipes to be shared or made visible to other users; track and expose how many time a recipe has been cooked (including by how many people); and the like. In some cases, a selected one or more recipes may be made visible by the cooking assistance service 203 to any number of users by default.

In some embodiments, one or both of the local hardware devices has a direct power connection to a power grid, such as via direct current via USB or alternating current via grid power provided by a wall plug. In some embodiments, one or both of the local hardware devices has uses a battery, or is even powered by residual thermal heat produced by a cooking surface, itself.

In embodiments, the sensory array 209 is focused on/directed towards one or more food preparation surfaces. During a food preparation session, the sensory array 209 collects sensory data for analysis by one or more of the sensory data processing components 206. The sensory array 209 includes a variety of sensors, including, for example one or more thermal sensor(s) 210 (e.g., visible light camera(s) and/or one or more visible light sensor(s) 211 (e.g., visible light camera(s)). When the sensory array 209 is mounted overhead, the thermal sensor(s) 210 and/or visible light sensor(s) 211 can be appropriately zoomed as needed to get the food preparation surface in the view.

Sensor data from the thermal sensor(s) 210 provides visibility into the surface temperature of a food preparation surface, and/or objects associated therewith, during a food preparation session. In embodiments, the thermal sensor(s) 210 collect sensor data over a grid area of pixels (i.e., a thermal sensory array). In various implementations, this grid area covers a region comprising about 32×24 pixels, 32×32 pixels, or 80×62 pixels, though other grid area sizes may also be used. In embodiments, the thermal sensor(s) 210 additionally, or alternatively collect sensor data using one or more thermal probes (e.g., wired or wireless) that measure internal food temperatures. In some implementations, thermal sensor(s) 210 could even comprise a camera visually monitoring a thermometer.

In embodiments, the thermal sensor(s) 210 detect, sense, or have a temperature awareness of a food preparation surface, cookware, food, etc. In embodiments, one or more of the sensory data analysis components 208 use sensor data collected from the thermal sensor(s) 210 to accurately discern “action” awareness based on temperature profiles and changes (e.g., when food is added to a pan, when water begins to boil, when food is turned or moved). By way of example, when a liquid is added to a boiling mixture, sensor data from the thermal sensor(s) 210 is usable to detect a change in the mixture's temperature, and to intelligently determine that a new substance has been added to the mixture.

In some embodiments, the sensory data analysis component 208a uses sensor data collected from the thermal sensor(s) 210 in order to “wake up” the accessory device 201 and/or the UI computing device 202 (e.g., via a message from communications component 217a to communications component 217b) from a lower power state to a higher power state when a cooking surface is turned on.

In embodiments, one or more of the sensory data collection components 207 implement a thermal image capture module capable of capturing thermal sensor data from thermal sensor(s) 210. In embodiments, one or more of the sensory data analysis components 208 implement a thermal image processing module capable of processing this thermal sensor data, such as to also convert a thermal matrix into a thermal image, and then allows the thermal image and/or the thermal matrix to be accessible to an object detection algorithm (e.g., using one or more of the ML engines 205).

In embodiments, the visible light sensor(s) 211 include one or more visible light red, green, blue (RGB) cameras, one or more monochromatic cameras, or any other type of visible light camera(s). In embodiments, using sensor data from the visible light sensor(s) 211, one or more of the sensory data analysis components 208 detect objects used as part of the cooking process, including pans or food items placed in pans. In embodiments in which the visible light sensor(s) 211, include multiple cameras, one or more of the sensory data analysis components 208 may use sensor data collected from the visible light sensor(s) 211 in order to determine depth.

In embodiments, the visible light sensor(s) 211 are used to record or stream a video feed that can be used as part of the cooking process or to produce a record of what has been cooked. In some embodiments, the UI computing device 202 or the cooking assistance service 203 uses this recorded video feed to generate a shortened recipe “highlight reel” or “trailer” that includes video clips from the video feed that emphasize important cooking actions/steps, such as clips of ingredients being added; clips of ingredients being mixed, flipped, stirred, etc.; a visual representation of temperature and/or timing information; and the like.

In embodiments, one or more of the sensory data collection components 207 implement a visible light image capture module capable of capturing images/video from the visible light sensor(s) 211. In embodiments, one or more of the sensory data analysis components 208 implement a visible light image processing module capable of processing this visual data, such as by feeding to an object detection algorithm (e.g., using one or more of the ML engines 205).

In embodiments, one or more of the sensory data analysis components 208 use sensor data collected from the thermal sensor(s) 210 and from the visible light sensor(s) 211 to generally detect movement or changes to an observed object, such as the addition of cookware, the addition of an ingredient, the flipping of an ingredient, the stirring of an ingredient, etc. In embodiments, one or more of the sensory data analysis components 208 use sensor data collected from the thermal sensor(s) 210 and from the visible light sensor(s) 211 to detect thermal qualities of specific pans and/or burners.

As indicated by the ellipses within the sensory array 209, the sensory array 209 can include any number of additional sensory devices. For example, in some embodiments the sensory array 209 includes a distancing sensor, such as a laser range finder, ultrasound, radar, multiple cameras of the visible light sensor(s) 211, thermometers, thermal probes, etc. This distancing sensor is usable to understand or determine distance and/or positioning information and to potentially even calibrate one or more other sensors (e.g., the thermal sensor(s) 210 and/or the visible light sensor(s) 211). In some implementations, the distancing sensor is able to detect one or more of a vertical height of the sensory array 209 with respect to a food preparation surface, a size of the cookware being used (e.g., a 7 inch pan or a 10 inch pan), a size of the food that is being cooked, a thickness of the food being cooked, and the like.

In some embodiments the sensory array 209 includes a barometric sensor. In these embodiments, the barometric sensor is used to determine ambient air pressure and, by extension, an altitude of the cooking environment. With knowledge of the altitude of the cooking environment, the intelligent cooking assistant is able to automatically make attitude adjustments to digital recipes, such as cooking time, ingredient proportions, etc.

In some embodiments the sensory array 209 includes a humidity sensor. In these embodiments, the humidity sensor is used to determine the relative humidity of the cooking environment. This determination may be performed at any time, such as prior to a food preparation session, as well as during a cooking process as steam is potentially generated. With knowledge of the humidity of the cooking environment, the intelligent cooking assistant is able to automatically food/ingredient state (e.g., whether or not liquid is boiling); to make adjustments to digital recipes, such as cooking time, ingredient proportions; and the like.

In some embodiments the sensory array 209 includes a gas sensor. In these embodiments, the gas sensor may be used to sense or “smell” the food as part of the digital recipe, to alert the cook if there are toxic or otherwise harmful gases, to alert the cook as to fire or explosion hazards, etc.

In some embodiments the sensory array 209 includes a radar sensor. In these embodiments, the radar sensor is used for motion and object detection, and may be used in conjunction with the visible light sensor(s) 211.

In some embodiments the sensory array 209 includes an audio listening sensor (e.g., microphone). In some embodiments, the audio listening sensor is used to capture cooking-related audio feedback, such as the “sizzle” sounds of the cooking process. In embodiments, the intelligent cooking assistant is able to use such audio feedback as part of creation of a recipe (e.g., to be paired with video and surface temperature data for analysis by one or more of ML engines 205), or as part of determining how a live food preparation session tracks a recorded recipe. In additional, or alternative, embodiments the audio listening sensor is used to record voice commentary, instructions, or other content that a chef speaks as part of recording a digital recipe, such as to verbally identify ingredients and cooking steps during recipe creation (which verbal identifications are used, for example, as an input to one or more of ML engines 205). In embodiments, the audio listening sensor also enables a chef to have a voice control interface to the intelligent cooking assistant (e.g., ask the system when the water will boil, to skip to the next step of a recipe, etc.). In some embodiments, the audio listening sensor is configured to activate one or more of the accessory device 201 or the UI computing device 202.

In embodiments, the UI computing device 202 is the primary way that a user/cook interacts with the intelligent cooking assistant architecture 200. As described earlier, any type of computing device may be used as the UI computing device 202, including any type of mobile device (e.g., smartphone, tablet, laptop, head-mounted display/device, etc.) as well as non-mobile devices (e.g., desktop). In some embodiments, the UI computing device 202 is integrated into a so-called “smart hood,” where this smart hood functions as a regular cooking range hood, but it is further embedded with a display as well as the various other sensors mentioned herein.

In embodiments, the UI computing device 202 is configured for user interaction via user input/output device(s) 216 (IO device(s) 216). As used herein, the IO device(s) 216 can include any of the sensory devices discussed in connection with the sensory array 209 (e.g., by virtue of sensory data communicated between communications component 217a and communications component 217b). In embodiments, the IO device(s) 216 enable the UI computing device 202 to receive user input via at least one of voice command, touch input, or gesture input. In various embodiments, gesture input could include human gestures (e.g., hand motion) and or physical object gestures (e.g., tapping a spatula on a pan).

In some implementations, the UI computing device 202 includes one or more speakers. A speaker allows the UI computing device 202 to provide numerous different user-facing features, such as voice instructions to the chef (e.g., “Turn down the heat to medium” or “Time to flip the eggs”), audible warnings/alerts (e.g., if a timer goes off, if a cooking surface has been left unattended too long, etc.), an audible background sound that changes pitch with respect to changes in temperature as determined by the infrared sensor array (e.g., higher pitch means hotter temperatures), and the like.

In some implementations, UI computing device 202 also includes a touchscreen display. In some cases, the touchscreen display is the primary interface for presenting sensor data to a chef as well as for providing a touch interface in order to control the UI computing device 202. Separate from a connected touch display, the same display information and control interface may be presented via a web-browser interface to a computer, tablet, smart phone or other device capable of running a web-browser.

In embodiments, the accessory device 201 and the UI computing device 202 operate as a standalone system, while in other embodiments the accessory device 201 and the UI computing device 202 operate in combination with the cooking assistance service 203. As shown, the intelligent cooking assistant architecture 200 includes one or more cooking assistant components 212 (i.e., cooking assistant component 212a at the UI computing device 202, and cooking assistant component 212b at the cooking assistance service 203). These cooking assistant components 212 provide the primary logic of the intelligent cooking assistant, and can include one or more corresponding presentation components 213 (i.e., presentation component 213a at the UI computing device 202, and presentation component 213b at the cooking assistance service 203), one or more corresponding recipes 214 databases (i.e., recipes 214a database at the UI computing device 202, and recipes 214b database at the cooking assistance service 203), and a social service 215. In embodiments, the social service 215 provides social media features, as will be discussed in more detail infra.

In embodiments, one or more of the cooking assistant components 212 are configured to use of sensor data collected by the sensory array 209 in real-time (or near real-time). In some environments, such as a restaurant, real-time interaction with the cooking assistant component 212a may not be needed, and data from the sensory array 209 may be passively logged to the cooking assistant component 212b for offline analysis.

In various embodiments, one or more of the cooking assistant components 212 are implemented as a web application and/or as a native device application (e.g., downloadable applications). Web applications may run on any software OS platform, including Android, iOS, Windows, and so forth. The applications may also run on any type of computing device. For example, a recipe may be created at the food preparation surface with an android tablet recording data and user interaction through an Android GUI. Later, however, the recipe may be edited on a computer and shared with others.

In embodiments one or more of the presentation components 213 implement an “overlay composite” module, which use augmented reality (AR) techniques to overlay a thermal image (e.g., derived from the thermal sensor(s) 210) on top of a visible image (e.g., captured by the visible light sensor(s) 211) to thereby create a composite image having multiple layers, including a visible light data layer and a thermal data layer. The overlay composite module also enables exploration of overlaying temperature vs. overlaying a colored thermal image. In embodiments, the overlay can be adjusted for various heights or viewpoints.

In embodiments, one or more of the cooking assistant components 212 implement object detection (e.g., in connection with one or more of the sensory data analysis components 208 and/or one or more of the ML engines 205), which uses both the thermal sensor(s) 210 and the visible light sensor(s) 211 to identify changes that are happening to the food preparation surface. This includes triggering operations in response to certain timing references or timing conditions. In embodiments, object detection also includes the ability to track objects on a per burner basis.

In some embodiments, the process of performing object detection includes detecting food preparation surface and/or burner conditions. For instance, a training procedure may identify cooking surface burners through a step by step process that prompts a user turns on one burner at a time until all burners are identified and located (e.g., using the thermal sensor(s) 210). Another example of object detection includes detecting when items are added to the cooking burner (e.g., using the thermal sensor(s) 210 and/or the visible light sensor(s) 211). For example, the embodiments may detect a pan, food items, and even seasoning. Yet another example of object detection includes detecting when pans are removed from the cooking burner or even detecting the cooking burner type (gas, electric, induction).

### Cooking Dashboard

In embodiments, one or more of the cooking assistant components 212 provide a “dashboard” for browsing and obtaining recipes, as well as AR experiences for both “freestyle” recipe creation sessions and “scripted” recipe guidance/instruction sessions. In embodiments, this cooking dashboard is presented by one or more of the presentation components 213 (e.g., as a native user interface appropriate for the UI computing device 202 by the presentation component 213a, and/or as a web user interface by the presentation component 213b). In embodiments, one or more of the cooking assistant components 212 are structured to enable a chef to have visual access to sensor data in real-time during a food preparation session (e.g., via an AR overlay), and to catalogue the time and temperature of activities that have occurred in the food preparation session (e.g., generate log data or audit data). As indicated, a food preparation session may be either “freestyle” or “scripted.” As used herein, a “freestyle” food preparation session is one where a cook is not following any instructions (e.g., as part of recipe recording/generation) while a “scripted” food preparation session is one where the chef is following a digital recipe.

Regardless of the type of food preparation session, in embodiments, one or more of the cooking assistant components 212 keep track of events that have occurred during the food preparation session, and their corresponding presentation components 213 to present a list of events in a visual manner to the cook or even any subsequent cooks. The accessory device 201 can detect (e.g., via sensory array 209) when food, liquid, seasoning, and so forth are added to the cooking environment. Detecting these events can be used for a number of functions and behaviors that are displayed on the cooking dashboard.

In embodiments, using the sensory array 209, detectable events include one or more of that cooking has started; that a cooking step has started; that food has been flipped, stirred or otherwise attended to; that a transition from one step in a recipe to another has occurred; that an ingredient has been added; that cooking has not been attended to (i.e., for purpose of generating an alert); that cooking has reached an actionable stage (e.g. water boiling); that a cooking time has been reached (time to flip egg); that a pan has heated up sufficiently for the cooking process to begin; that food preparation session data should be logged; that a cooking step had ended; that cooking has ended; and the like.

Regardless of whether or not a food preparation session is freestyle or scripted, in embodiments non-visual sensor data (i.e., generated by the sensory array 209) is logged (e.g., by one or more of the cooking assistant components 212) for a configurable amount of time. Additionally, metrics from that data may be archived by one or more of the cooking assistant components 212) and used for analysis purposes to learn and customize cooking information for specific end user environments. The metrics may also be used for determining user preferences. For example, a particular pan that a user has may have different thermal qualities (e.g., a cast iron skillet vs aluminum pan) and the cooking assistant components 212 are able to adjust time/temperature information based on the use of the cast iron skillet.

### Recording and Editing Recipes

In embodiments, one or more of the cooking assistant components 212 are configured to perform recipe recording operations. These abilities or operations include the ability to employ object detection to automatically identify changes to the food preparation surface. The abilities also include the ability to interact with the user and allow manual modification of the recipe as it is being made live.

In some embodiments, one or more of the cooking assistant components 212 give the user the ability to start recording a recipe and can then capture one or more of visible and thermal imaging data using sensory array 209. The system may then analyze both visible and thermal data in real time and prompt the user when things are noticed. In some cases, one or more of the cooking assistant components 212 allow the user to identify each object as it is added and also to record temperatures and timing as objects are added. In embodiments, one or more of the cooking assistant components 212 can also record audio and ensure alignment between video and audio segments.

In embodiments, recording a recipe creation/generation event (or perhaps an event in which an existing recipe is being followed) utilizes the intelligent cooking assistant architecture 200 to record audio, video, timing, and sensor information in a synchronized data format for an entirety of a food preparation session. In embodiments, the session is initiated and terminated using user input (e.g., such as selection of a UI button or voice command), or using automated event detection (e.g., the system begin recording upon detection of preparations made for cooking). Once a digital recipe is created, it can be stored in recipes 214.

Additionally, some embodiments encode metadata with the audio or video recording in order to maintain relative timing data when video is removed or inserted. Additionally, the metadata may be encoded separately with timing data using some external synchronization method. One potential implementation is to encode markers within the audio/video recording at a given pixel or point in audio that would indicate timing.

In accordance with the disclosed embodiments, a recipe may be dynamically edited in real-time or at any time during the lifespan of the recipe. Editing a recipe includes accessing a recorded recipe session and condensing that session down to a user defined level of detail (i.e. a granular level). The editing preserves the original timing and temperature metadata regardless of the compressed audio or video content duration. This enables advanced modifications to be performed on the recipe. If metadata is preserved within the audio or video stream, video editing software can be utilized by the end user as desired.

In conjunction with recipe recording, embodiments also include the ability to edit recipes and/or recipe videos or other instructions. For instance, once a recipe has been recorded, it may optionally be edited by the user and published to the social service 215 as is a “recipe” file that can be uploaded and shared. Therefore, a recipe can be “downloaded” or “shared” as a file which can be loaded into the cooking assistant and used to reproduce a recipe. Other users will be presented with the option to “download” or “buy” recipes and load them into their cooking assistants. In some embodiments, a recipe file is a container that includes not only a textual description of a recipe but additional information as well, such as the thermal and other sensor information. In some embodiments, the process of editing a recipe includes initially ensuring alignment of all metadata, even when a video recording of recipe creation is cut. The process may also include allowing modifications to an ingredient list and allowing additional text and custom text to be added to the recipe or video. In some cases, closed captioning text may also be included or added to a video. In embodiments, editing allows for the option to show all timing data to the user, and allow timing to be modified (e.g., when items were added, and how long they cooked). The editing also allows the finished recipe to be published and shared and even to show a list of recorded recipes. A management interface may be provided to create, delete, modify, republish, or share the videos and recipes.

### Social Media Features

Some embodiments of the intelligent cooking assistant architecture 200 are enabled to publicly or privately publish or share a recipe (i.e., via the social service 215). In embodiments, the social service 215 shares recipes with selected entities, or even publicly to the entire world. In embodiments, sharing a recipe includes sharing audio, video, temperature data, metadata, an ingredient list, and written or verbal instructions, or any other data. Sharing a recipe may include interactive communication and comments in addition to the ability to download the recipe directly to a client device (e.g., even another client device hosting its own instance of the cooking assistant).

In embodiments, sharing a recipe includes sharing an automatically generated shortened “highlight reel” or “trailer” of recipe creation, which includes recorded video clips that emphasize important cooking actions/steps, such as clips of ingredients being added; clips of ingredients being mixed, flipped, stirred, etc.; a visual indication of temperature and/or timing characteristics; and the like.

This sharing process may include any level of privacy restrictions or controls. Such privacy controls may include controlling visibility groups as well as global visibility.

The use of the intelligent cooking assistant architecture 200 in scripted food preparation sessions enables cooks to be able to provide authoritative feedback to recipe authors, and potentially provide trusted reviews or compensation to the author, available through the social service 215. In embodiments, from logged information, the social service 215 authenticates that a cook has actually followed a recipe by comparing time/temperature data from the food preparation session to the author's original instructions. The time/temperature data from a food preparation session provides a “proof of work” analogous to the proof of work concept used in cyber currency. By incorporating a limited amount of automatic feedback from a food preparation session via the proof of work, the social service 215 ranks and/or sorts community recipes by popularity. Additionally, the social service 215 may enable recipes to be tagged by a level of difficulty. That is, the level of difficulty may delineate how hard is it to accurately reproduce or follow the recipe. This can be determined by comparing the variances of the “proof of work” reproductions versus the original recipe. In this regard, the social service 215 may maintain a repository of cooking results from any number of cooks, where the repository details the results of those cooks' efforts in following the recipe. These efforts may be analyzed to assign or gauge a level of difficulty for the corresponding recipe.

In embodiments, the intelligent cooking assistant architecture 200 provides, via social media features, an indication of how many times a recipe has been cooked, and/or by how many people. By being exposed to such information, the intelligent cooking assistant architecture 200 can provide amateur home chefs level of “confidence” in the accessibility/difficulty of a recipe for average users.

In embodiments, users can comment on other recipes and perform normal actions such as “like” or “dislike.” Additionally, as users post reviews, they can assess or assign a star rating to a recipe. Users can also “tip” other users as a form of gratitude. In some cases, the system provides a billing component tied to a user account to enable to send or receipt of a tip/gratuity.

### Open-Loop Recipe Compensation

In embodiments, one or more of the cooking assistant components 212 are configured to recognize that environmental factors (e.g., barometric pressure, humidity, pan's thermal qualities, etc.) as well as user control of cooking surface temperature will vary from food preparation session to session. In embodiments, the one or more of the cooking assistant components 212 are able to automatically adjust recipes, such as cooking time and desired temperature in order to result in more consistent outcomes. For example, if the recipe called for cooking a steak for 4 minutes at 450 degrees before flipping, and the current pan is at only 400 degrees, the recipe may be auto adjusted to say that the user should wait 4 minutes and 30 seconds before flipping. In some embodiments, preference is given first to adjust time, and secondly to inform the chef to adjust the cooking surface temperature.

In some cases, one or more of the cooking assistant components 212 are able to receive user input (or even video input) identifying which ingredients are currently available in a cook's pantry, to compare the generated list of ingredients against recipes 214, and to automatically identify which recipes the cook can immediately prepare using only the ingredients currently available in his/her pantry. In this regard, one or more of the cooking assistant components 212 can not only help facilitate following a recipe, but also help facilitate a selection of a recipe based on the currently-available listing of ingredients. For instance, one or more of the cooking assistant components 212 may use any type of machine learning or automata learning (i.e., using one or more of the ML engines 205) to identify ingredients and perform the comparison process.

As used herein, reference to any type of machine learning may include any type of machine learning algorithm or device, automata learning, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

Generally, automata learning is a type of machine learning technique in which a current process or action is performed based on a set of previous actions or experiences that were performed. In some cases, automata learning is a type of reinforcement learning and is based on various different states or statuses of data.

In embodiments, one or more of the cooking assistant components 212 have the ability to learn from the cooking experiences of a combined user base. This learning can be in the form of recipes that are popular, liked, not liked, and so forth. This can also include more complex operations like big-data/machine learning and conclusions of how food is best prepared. Additionally, the machine learning algorithm may be trained to dynamically adjust the recipe requirements based on any of the sensor data described herein as well as based on specific user preferences. For instance, a particular chef or cook may prefer to always substitute one ingredient for another (e.g., applesauce for sugar). The machine learning is able to progressively learn these preference traits and apply them to future recipes in which those preferences may be determined to be applicable. In some cases, this substitution may occur automatically while in other cases the substitution may invoke or trigger user approval before making the substitution.

Once a recipe is recorded, edited, and shared it can then be cooked by the world (or whoever the recipe has been shared with). When cooks then go about following the recipe, it is during this stage when the user/cook has a significantly enhanced level of information available to utilize when cooking.

### Safety Detection/Alerting

In embodiments, data from the sensory array 209 is used (e.g., buy one or more of the sensory data analysis components 208) to diagnose unsafe situations and notify/alert when situations arise. Some non-limiting examples of unsafe conditions include detection as to when a hot burner has been left unattended for a determined period of time (e.g., using thermal sensor(s) 210 and lack of motion over a period of time), detection of a scenario in which a human is reaching for a hot pan without protection, detection of the presence of toxic or combustible gases, and the like. Additional detections include identifying when young children are near the hot stove or when a grease fire has started.

To facilitate the safety operations as well as any other operation disclosed herein, in embodiments one or more of the cooking assistant components 212 detect individual pots and pans, and generate meta-information regarding the thermal qualities of the pan. This meta-information includes visually identifying information about the pan, including the make/model, size, material (e.g., aluminum, cast iron, etc.); determining what areas of the pan heat/cool faster than other areas of the pan; measuring the thermal capacitance of the pan; and the like. As part of these detection processes, there may be a pan calibration process by which a pan is subject to a specified heat setting available for a certain amount of time, after which the heat source is removed, in order to determine the heating capacity of the pan and/or heating surface. Other types of calibration may be performed as well.

### Additional Features

The disclosed embodiments provide an intelligent cooking assistant architecture 200 that can act as a cooking coach/assistant as a user creates a previously-recorded recipe. Some additional features of this intelligent cooking assistant architecture 200 include the ability to allow searching for recipes; to allow downloading of recipes; to allow playback/start of recipe; to provide interactive prompts and text to speech voice commands as the recipe is followed; to perform object detection in an attempt to identify each of the ingredients as they are added; to allow the user to confirm whether an ingredient is added; to provide prompts based on timing when it is time to turn, stir, flip or add; and the like

As recipes are followed by multiple people, the session information from all of these sessions can be grouped to provide additional feedback to the original recipe in order to provide reporting mechanisms for the recipe. These reports may indicate information including the difficulty in following the recipe and even whether the recipe yielded the result that was expected, like a review of the recipe.

In embodiments, the intelligent cooking assistant architecture 200 is usable to provide on-the-fly coaching from a cooking professional. Thus, for example, rather than (or in addition to) guiding a user through an electronic recipe, the intelligent cooking assistant architecture 200 could present a “live” meeting with a professional cook, where the professional cook receives a real-time sensor feed and/or screen share of the user's food preparation session from the intelligent cooking assistant architecture 200 in order to coach/guide the user.

In embodiments, the UI computing device 202 provides audio and/or visual cues to emphasize the urgency of certain instructions. For example, when instructing a user to “turn up the heat” or “turn down the heat,” UI computing device 202 may visually and/or audible convey both the urgency of the instructions (i.e. do it now vs. do it soon), as well as the intensity of a corrective action (i.e. turn the heat up a lot vs., turn it up a little).

In embodiments, the intelligent cooking assistant architecture 200 enables sponsored ingredient substitutions. For example, one or more of recipes 214 may be sponsored, such that generic ingredients such as “butter” might be substituted by sponsored non-generic versions.

In embodiments, the intelligent cooking assistant architecture 200 captures and instructs non-cooktop related steps as part of recipe creation and coaching, such as step taken at a cutting board or food preparation surface. In embodiments, these steps a captured by the accessory device 201, or may be captured by a 3rd party device and separately provided and linked to the recipe information captured by the accessory device 201. This can include both steps that happen before the cooking, as well as afterwards (e.g., including the final presentation of the dish).

In embodiments, the intelligent cooking assistant architecture 200 provides a library of stock video instruction related to preparation steps. This allows a recipe creator to allow the inserting of stock video instruction of preparation steps as part of an overall recipe. For example, when the intelligent cooking assistant architecture 200 detects that chopped onions have been added during a recorded food preparation session, it could automatically add stock video footage of a professional chef chopping onions as a preparation step to the final published video recipe.

### Example Methods

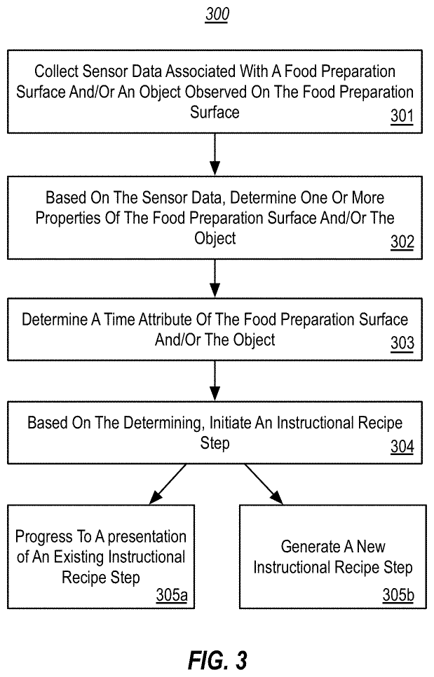

Attention is now directed to FIG. 3, which refers to a method and method acts that may be performed. Although the method acts may be discussed in a certain order or illustrated in a flow chart as occurring in a particular order, no particular ordering is required unless specifically stated, or required because an act is dependent on another act being completed prior to the act being performed.

FIG. 3 shows a flowchart of an example method 300 for providing interactive cooking experiences. As will be appreciated, method 300 can be performed at one or more of the accessory device 201, the UI computing device 202, or the cooking assistance service 203 of the intelligent cooking assistant architecture 200.

Initially, method 300 includes an act (act 301) of collecting sensor data associated with a food preparation surface and/or an object observed on the food preparation surface. In some embodiments, act 301 comprises collecting, using a sensory array, sensor data associated with at least one of, (i) a thermal property of at least one of a food preparation surface or an object on the food preparation surface as observed by at least one thermal sensor, or (ii) a visual property of at least one of the food preparation surface or the object as observed by at least one visible light sensor. In an example, the sensory array 209 obtains sensor data associated with a thermal property using the thermal sensor(s) 210, and/or obtains sensor data associated with a visual property using the visible light sensor(s) 211, and this sensor data is collected by one or more of the sensory data collection components 207. In some implementations, act 301 is performed by the accessory device 201 (i.e., using sensory data collection component 207a), while in other implementations act 301 is performed by the UI computing device 202 (e.g., the using sensory data collection component 207b, under direction of the cooking assistant component 212a) or by the cooking assistance service 203 (e.g., the using sensory data collection component 207c under direction of the cooking assistant component 212b).

Method 300 also includes an act (act 302) of, based on the sensor data, determining one or more properties of the food preparation surface and/or the object. In some embodiments, act 302 comprises determining, based on the collected sensor data, at least one of, (i) based at least on the thermal property, a temperature of at least one of the food preparation surface or the object; or (ii) based at least on the visual property, at least one of an identity or a physical property of the food preparation surface or the object. In an example, one or more of the sensory data analysis components 208 use one or more object detection algorithms to determine the temperature, identity, or physical property of the food preparation surface and/or an object at the food preparation surface. It is noted that, in act 302, determining a temperature of the object can include determining one or more of a surface temperature of the object (e.g., using an infrared sensory array), or an internal temperature of the object (e.g., using a temperature probe, or by interpolating changes in surface temperature over time). In embodiments, one or more of the sensory data analysis components 208 utilize one or more of the ML engines 205. In some implementations, act 302 is performed by the accessory device 201. In other implementations, act 302 is performed by the UI computing device 202 or the cooking assistance service 203 (i.e., based on the accessory device 201 having sent at least one of the determined temperature, identity, or physical property of the food preparation surface or the object to at least one of the UI computing device 202 or the cooking assistance service 203).

The physical property of the object can comprise any property detectible visually, such as at least one of a color of the object, a size of the object, or a thickness of the object.

Method 300 also includes an act (act 303) of determining a time attribute of the food preparation surface and/or the object. In embodiments, a time attribute may comprise an amount of time the food preparation surface has been heating; an amount of time the object has been present on the food preparation surface; a time at which an object was placed on the food preparation surface; a time at which the object was placed on the food preparation surface; an amount of time the object was on the food preparation surface prior to at least one of the temperature, identity, or physical property of the object being determined; and the like.

Method 300 also includes an act (act 304) of, based on the determining in acts 302 and 303, initiating an instructional recipe step. As shown, initiating the instructional recipe step can include an act (act 305a) of progressing to a presentation of an existing instructional recipe step, or an act (305b) of generating a new instructional recipe step.

In embodiments, act 305a comprises (i) progressing to a presentation of an existing instructional recipe step at a user output device based on at least one of the determined temperature, identity, or physical property of the food preparation surface or of the object, and further based on the determined time attribute. In some embodiments, act 305b comprises generating a new instructional recipe step, the new instructional recipe step being based on at least one of the determined temperature, identity, or physical property of the food preparation surface or of the object, and further based on the determined time attribute.

When act 305a is performed, method 300 comprises the presenting the existing instructional recipe step at the user output device. In embodiments, presenting the existing instructional recipe step at the user output device comprises presenting a user interface at a display device, the user interface including at least one of an indication of a desired ingredient, an indication of a desired cooking temperature, an indication of a desired cooking time, or a video of a prior recording of implementation of the instructional recipe step.

In embodiments, a time at which the instructional recipe step is presented, an amount of time for which the instructional recipe step is presented, and/or a time duration presented in connection with the instructional recipe step is based at least on the determined time attribute.

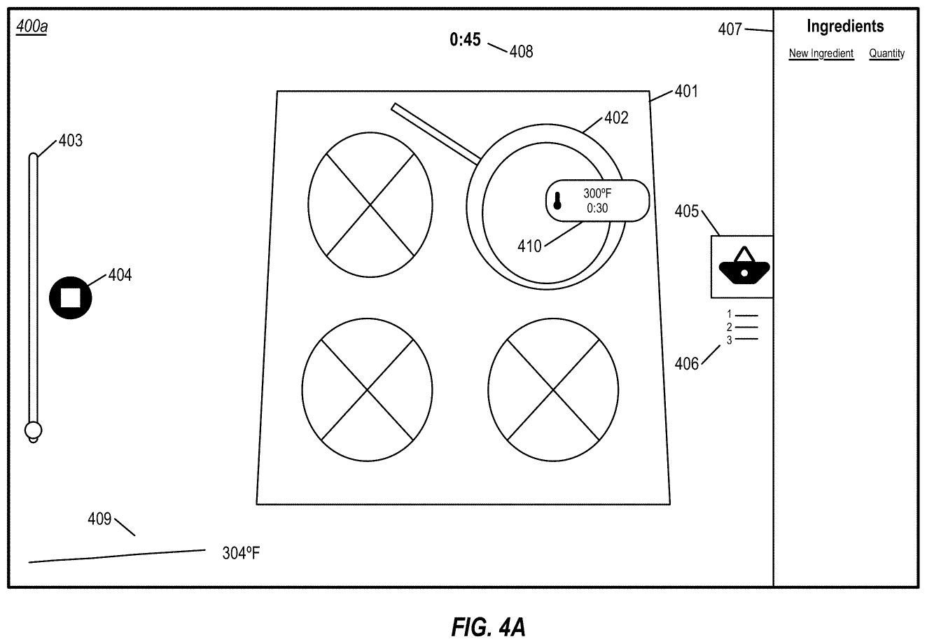

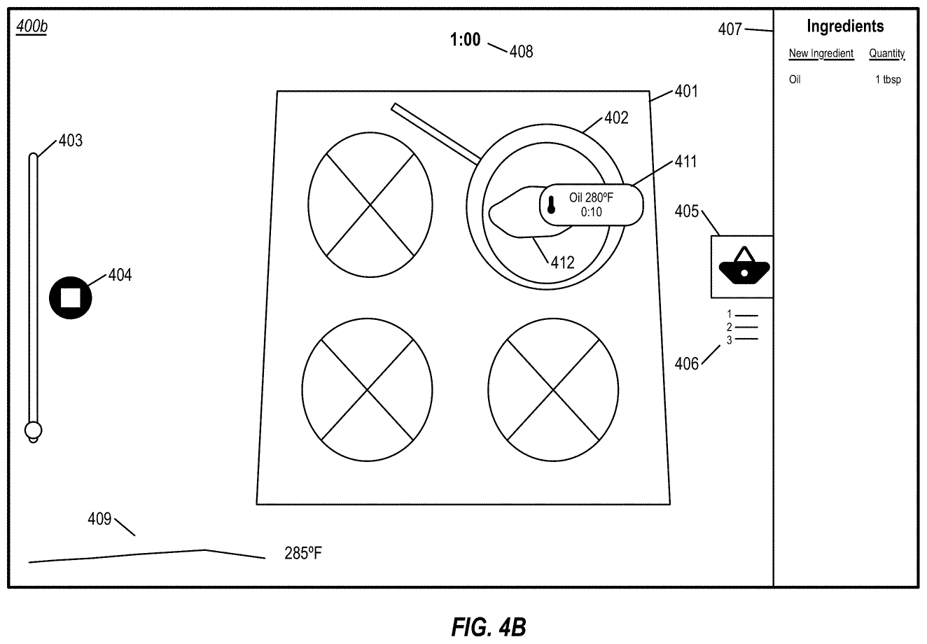

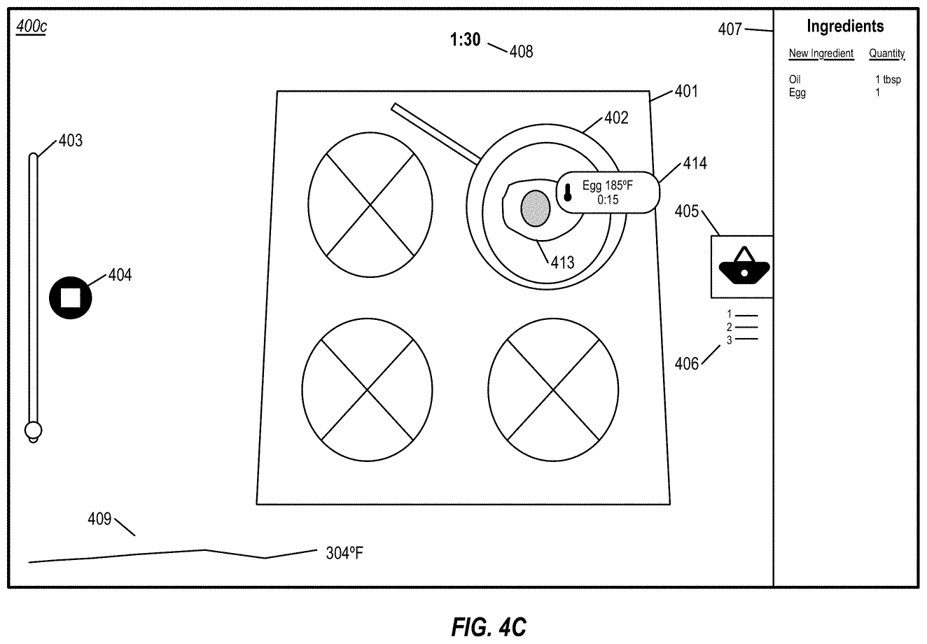

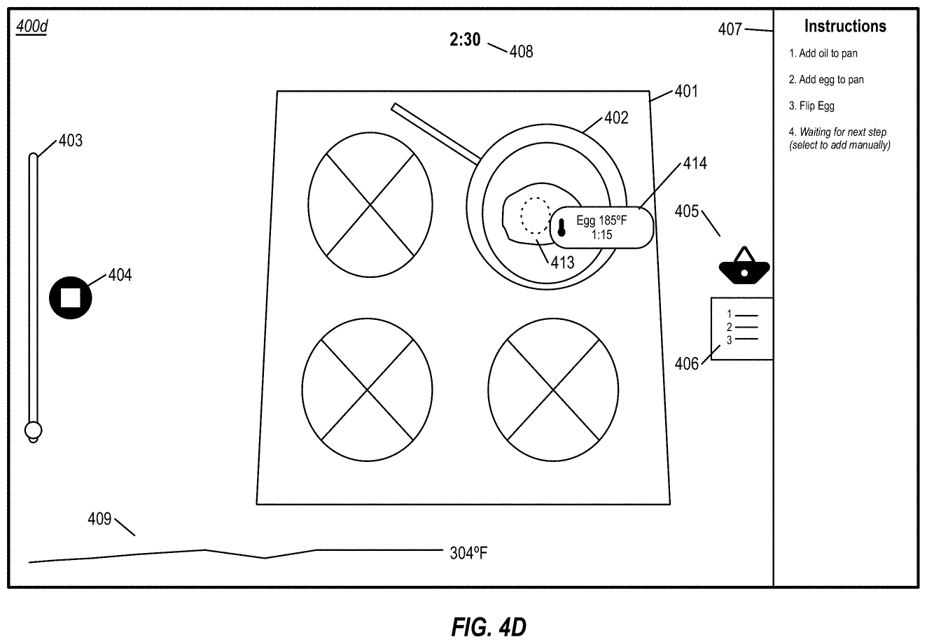

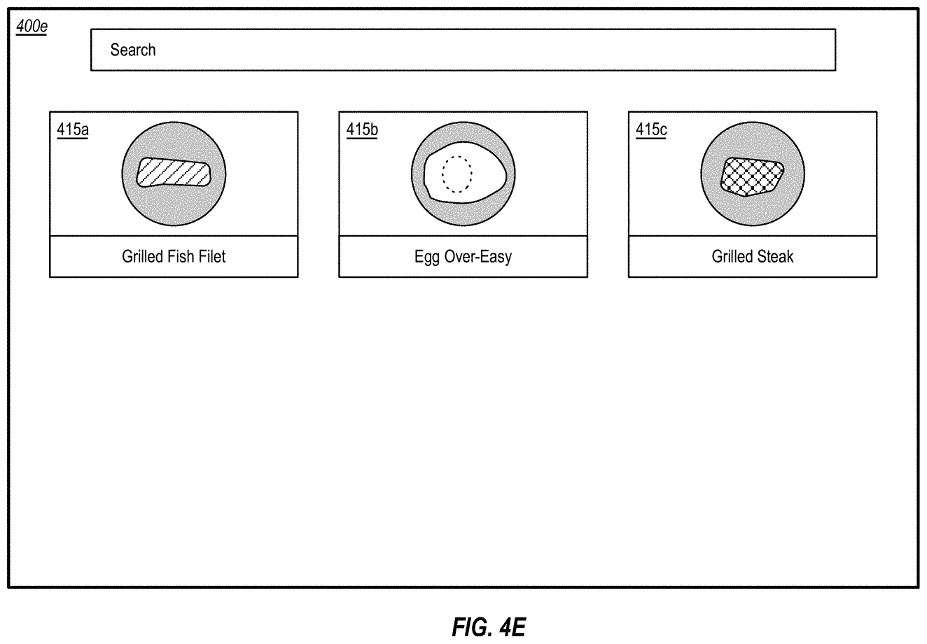

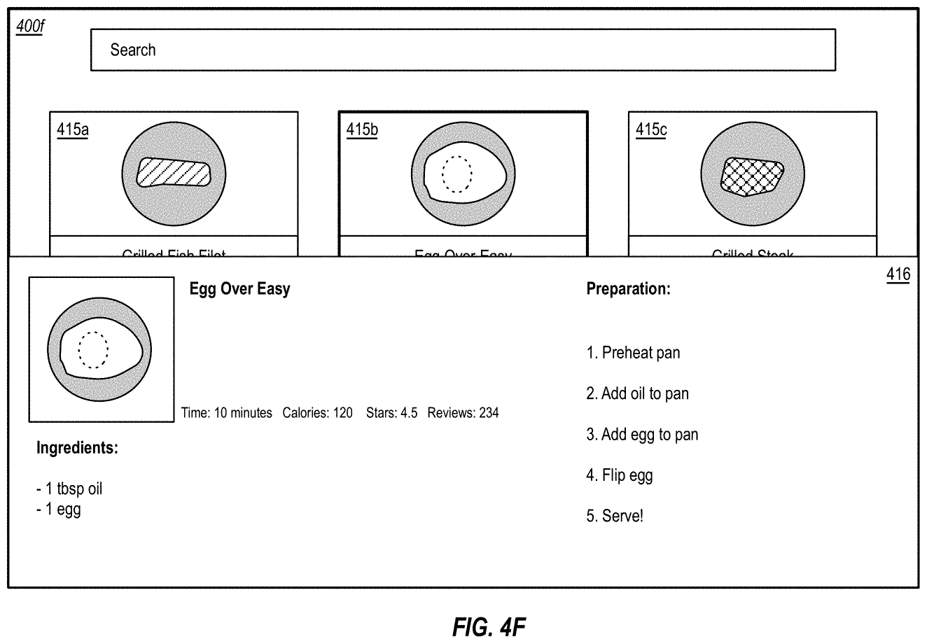

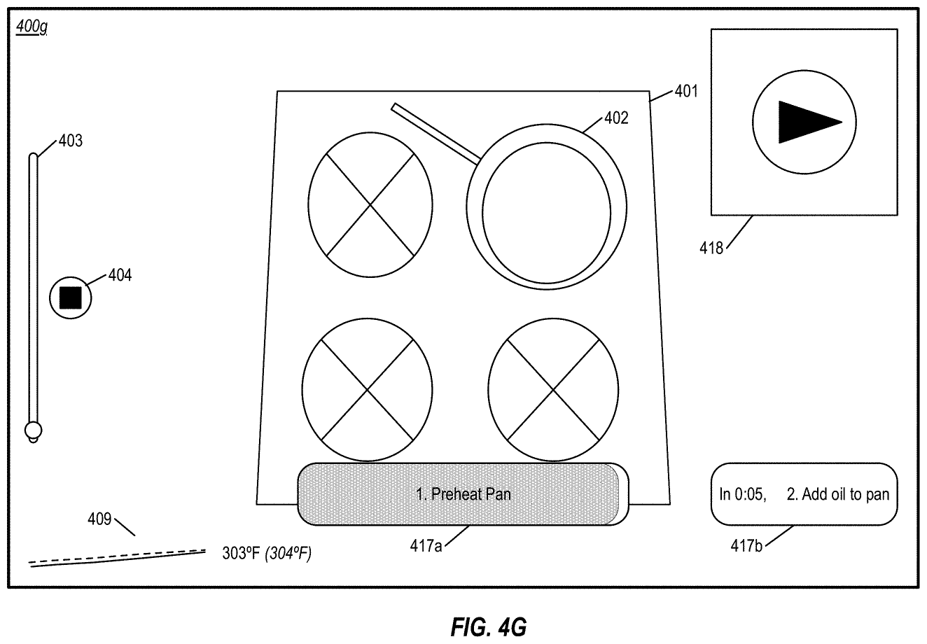

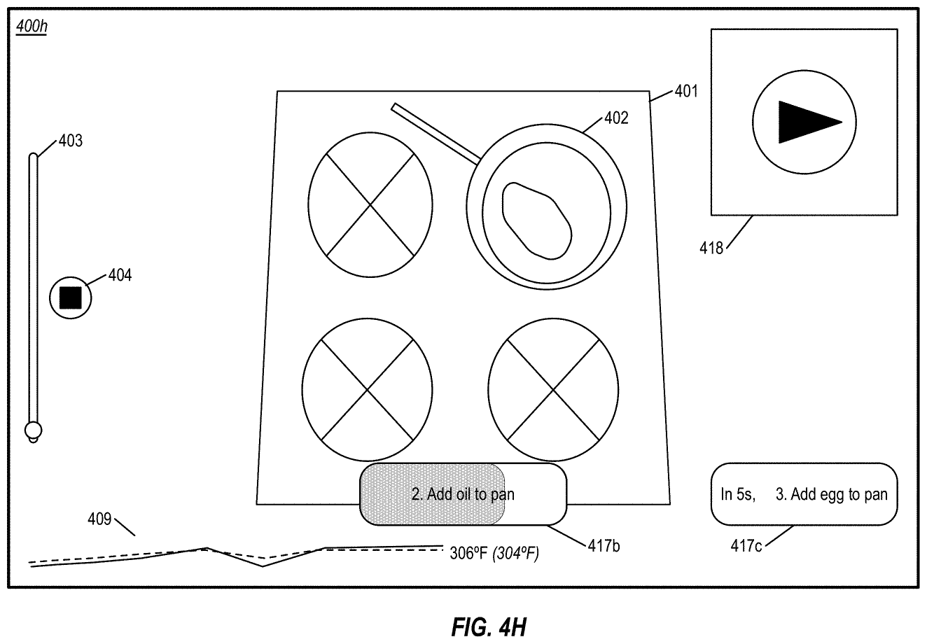

As will be demonstrated later in connection with FIGS. 4A-4H, the user interface presented in connection with act 305a can include a variety of interfaces and components, such as, for example: a dashboard interface that enables selection of a desired recipe; an instruction panel that presents a plurality of recipe steps; an ingredient panel that presents a plurality of recipe ingredients; a recording UI control that enables recording of a live food preparation session; a heatmap control that enables overlay over a temperature heatmap over the food preparation surface; a temperature pin that presents at least a temperature at a location associated with the food preparation surface; a temperature graph that presents at least one of historical cookware temperature observed by the accessory device, or goal cookware temperature obtained from a recipe; or a sharing control that enables publishing of at least one of a recipe generated during a live food preparation session, a video recording of the live food preparation session, or a highlight reel of the live food preparation session.

In an example of act 305a, one or more of the cooking assistant components 212 use the determined temperature, identity, or physical property of the object to select and present a next recipe step using one or more of the presentation components 213. For example, the determined temperature, identity, or physical property of the object may indicate that one recipe step (e.g., pre-heating a pan) has completed, so a subsequent recipe step is progressed to and presented.

In an example of act 305b, one or more of the cooking assistant components 212 use the determined temperature, identity, or physical property of the food preparation surface or of the object, along with the determined time attribute of the object, to identify attributes of a cooking step that was just demonstrated (e.g., ingredient, time, temperature, etc.), and generate a new step for a recipe that captures these attributes.

When act 305b is performed, method 300 comprises the generating the new instructional recipe step. In these embodiments, generating the new instructional recipe step comprises generating at least one of, a time component, a temperature component, an ingredient component, an ingredient preparation component, or a video component of the recipe step. In embodiments, the time component is based at least on the determined time attribute of the object, and comprises one or more a time at which the instructional recipe step is to presented (e.g., relative to another instruction step), an amount of time for which the instructional recipe step is presented, and/or a time duration presented in connection with the instructional recipe step.

### Example User Interfaces

FIGS. 4A-4H illustrate an example user interfaces 400a-400h that may be produced by one or more of the presentation components 213a/213b, and displayed at the IO device(s) 216 during the recipe generation and/or recipe following.

Initially, FIGS. 4A-4D illustrate example user interfaces 400a-400d that may be presented as part of a “freestyle” AR recipe creation session. Referring to FIG. 4A, illustrated is an example user interface 400a that includes a live view of a physical food preparation surface, including physical cookware 402 (as viewed by the visible light sensor(s) 211, for example). User interface 400a also includes several user interface controls, including a heatmap control 403 that enables overlay over a temperature heatmap over the food preparation surface(as detected by the thermal sensor(s) 210), and that can be used to control the opacity of the heatmap; a recording UI control 404 (illustrated as active) used to initiate and terminate a recipe recording session; an ingredients button 405 (illustrated as selected) used to show detected ingredients in an information panel 407 (i.e., as an ingredient panel); and an instructions button 406 (illustrated as inactive) used to show detected recipe steps in the information panel 407 (i.e., as an instruction panel). In embodiments, an ingredients panel delineates the specific ingredients and/or tools (e.g., which pots and pans) may be required to complete the recipe. In embodiments, an instruction panel delineates which operations or steps a chef is to follow in order to successfully follow a recipe, and is progressively generated while the chef is creating the recipe.

User interface 400a also shows a timer 408 showing a duration of the recipe recording session, as well as a temperature graph 409 graphing historic average surface temperature of the cookware 402 during the recipe recording session, and displaying a current average temperature of 304° F. (as detected by the thermal sensor(s) 210). As an AR feature, user interface 400a also illustrates a temperature pin 410 showing a point temperature of 304° F. for a single point in the cookware 402, along with a duration (30 seconds) for which the temperature pin 410 has been active. In embodiments, user interface 400a enables manual and/or automatic placement of any number of temperature pins, and these temperature pins automatically move to track the object to which they are associated.

Referring to FIG. 4B, illustrated is an example user interface 400b after 30 seconds have elapsed, and after which oil 412 has been added to the cookware 402. The temperature graph 409 shows that the average pan temperature has decreased to 285° F. (e.g., due to heating of the oil 412), and a new temperature pin 411 indicates that a point in the oil 412 is 280° F., with the temperature pin 411 being present for 10 seconds. In embodiments, the temperature pin 411 is added automatically based on one or more of the sensory data analysis components 208 having automatically detected the addition of the oil 412 to the cookware 402. In addition, the information panel 407 shows that one tablespoon of oil has been added as an ingredient.

Referring to FIG. 4C, illustrated is an example user interface 400c after another 30 seconds have elapsed, and after which an egg 413 has been added to the cookware 402. The temperature graph 409 shows that the average pan temperature has recovered to 304° F., and a new temperature pin 414 indicates that a point in the egg 413 is 185° F., with the temperature pin 414 being present for 15 seconds. In embodiments, the temperature pin 414 is added automatically based on one or more of the sensory data analysis components 208 having automatically detected the addition of the egg 413 to the cookware 402. In addition, the information panel 407 shows that one egg has been added as an ingredient. In embodiments, temperature pin 414 is bound to and tracks the egg 413, such as due to movement of the cookware 402, flipping of the egg 413, etc.

Referring to FIG. 4D, illustrated is an example user interface 400d after another minute has elapsed, and after which the egg 413 has been flipped. The temperature graph 409 shows that the average pan temperature remains at 304° F., and temperature pin 414 indicates that the egg 413 is 185° F., with the temperature pin 414 being present for one minute 15 seconds. In addition, the information panel 407 now shows recipe instructions (with the instructions button 406 now being active), including adding oil to the pan, adding an egg to the pan, and flipping the egg.

FIGS. 4E and 4F illustrate example user interfaces 400e 400f that may be presented as part of recipe selection. Referring to FIG. 4E, illustrated is a user interface 400e that includes a selection of available recipes 415a-415c, including a recipe 415b for an egg over-easy (e.g., as recorded in connection with presentation of user interfaces 400a-400d). FIG. 4F illustrates a user interface 400f that may be displayed after selection of recipe 415b, including a recipe information panel 416 that presents information, such as necessary ingredients, time to cook, a number of calories (e.g., as determined by the ingredients), ratings and/or reviews (e.g., as determined by social media features), and an overview of the recipe preparation process.

FIGS. 4G and 4H illustrate example user interfaces 400g and 400h that may be presented as part of a “scripted” AR recipe instruction session. Referring to FIG. 4G, illustrated is an example user interface 400g that includes a live view of a physical food preparation surface 401 including physical cookware 402 (as viewed by the visible light sensor(s) 211, for example). User interface 400g also includes several user interface controls, including the heatmap control 403 and the recording UI control 404 (illustrated as inactive) discussed previously. User interface 400g also includes the temperature graph 409, now showing two historical and current temperatures—one from the recorded recipe (i.e., using a broken line and italics) and one from the current food preparation session (i.e., using a solid line and non-italics). User interface 400g also includes an overlay of recipe steps 417 and instruction video section 418. In embodiments, the instruction video section 418 displays video clips—recorded during recipe creation—that are relevant to a current recipe step 417 (e.g., to instruct the chef on how to accomplish the current step) and/or a next recipe step 417 (e.g., to prepare the chef with knowledge regarding what step will be next). In embodiments, a current recipe step 417 is shown in the middle of the interface, along with a progress bar indicating an estimation time to completion the recipe step 417. For example, in user interface 400g, recipe step 417a for preheating the pan is active and nearly complete. The temperature graph 409 shows that the current pan temperature is 303° F., versus the recorded 304° F. In embodiments, a visual size of each recipe step 417 indicates which recipe step 417 is current (e.g., with the current recipe step 417 being visually larger than others), or an estimated relative duration of each recipe step 417. Notably, the temperature graph 409 could be presented in a variety of alternative manners, such as using a “speedometer” UI that shows the current temperature, with a bracketed region being used to show a target temperature range.

Referring to FIG. 4H, example user interface 400h shows that recipe step 417a for preheating the pan has completed, and that the user interface 400h has automatically advanced to recipe step 417b (which is nearing completion) for adding oil to the pan (e.g., when the oil reaches sufficient temperature to proceed to recipe step 417c of adding an egg to the pan). In embodiments, instruction video section 418 may present a video clip of the addition and heating of oil during the duration of step 417b.

Although not illustrated, embodiments automatically advance through the various steps recorded in connection with user interfaces 400a-400d until the recipe is completed, thereby guiding a chef though the ingredients, timing, and temperature characteristics of the recorded recipe. Also, although not shown, interfaces 400g and 400h could include additional elements from user interfaces 400a-400d, such as temperature pins, an ingredient panel, an instruction panel, and the like. Also, although not illustrated, a timer may indicate how long a chef is to perform a current action or how long to pause for a current action.

Accordingly, the disclosed embodiments generally relate to improved techniques for generating and providing recipe information. By providing an intelligent cooking assistant, chefs will be helped dramatically and recipe formation and following processes will be greatly improved.

### Example Computer/Computer systems

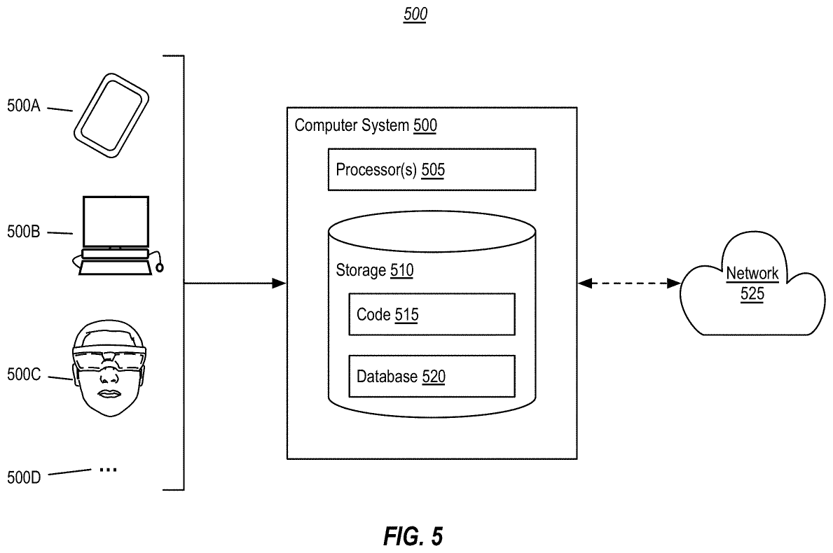

Attention will now be directed to FIG. 5 which illustrates an example computer system 500 that may include and/or be used to perform any of the operations described herein, including implementing one or more components of example architecture 200—such as accessory device 201, UI computing device 202, and/or cooking assistance service 203. Computer system 500 may take various different forms. For example, computer system 500 may be embodied as a tablet, a desktop, a laptop, a mobile device, or a standalone device, such as those described throughout this disclosure. FIG. 5 shows some specific implementations in the form of a tablet 500a, a laptop 500B, or even a wearable device 500C (e.g., a head-mounted device). The ellipsis 500D demonstrates how the computer system 500 may be embodied in any other form factor. Computer system 500 may also be a distributed system that includes one or more connected computing components/devices that are in communication with computer system 500.

In its most basic configuration, computer system 500 includes various different components. FIG. 5 shows that computer system 500 includes one or more processor(s) 505 (aka a “hardware processing unit”) and storage 510.

Regarding the processor(s) 505, it will be appreciated that the functionality described herein can be performed, at least in part, by one or more hardware logic components (e.g., the processor(s) 505). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

Storage 510 may be physical system memory, which may be volatile, non-volatile, or some combination of the two. The term “memory” may also be used herein to refer to non-volatile mass storage such as physical storage media. If computer system 500 is distributed, the processing, memory, and/or storage capability may be distributed as well.

Storage 510 is shown as including executable instructions (e.g., code 515) and non-executable data (e.g., database 520). The executable instructions represent instructions that are executable by the processor(s) 505 of computer system 500 to perform the disclosed operations, such as those described in the various methods.

The disclosed embodiments may comprise or utilize a special-purpose or general-purpose computer including computer hardware, such as, for example, one or more processors (such as processor(s) 505) and system memory (such as storage 510), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Computer-readable media that carry computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 500 may also be connected (via a wired or wireless connection) to external sensors (e.g., one or more remote cameras) or devices via a network 525. For example, computer system 500 can communicate with any number devices or cloud services (or may itself be in the cloud) to obtain or process data. In some cases, network 525 may itself be a cloud network. Furthermore, computer system 500 may also be connected through one or more wired or wireless networks 525 to remote/separate computer systems(s) that are configured to perform any of the processing described with regard to computer system 500.

A “network,” like network 525, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 500 will include one or more communication channels that are used to communicate with the network 525. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements.

What is claimed is:

1. A computer system for providing interactive cooking experiences, comprising:
one or more processors;
a sensory array; and
one or more hardware storage devices storing computer-executable instructions that, when executed by at least one of the one or more processors, cause the computer system to at least:
collect, using the sensory array, sensor data associated with at least one of, (i) a thermal property of at least one of a food preparation surface or an object on the food preparation surface as observed by at least one thermal sensor, or (ii) a visual property of at least one of the food preparation surface or the object as observed by at least one visible light sensor;
determine, based on the collected sensor data, at least one of, (i) based at least on the thermal property, a temperature of at least one of the food preparation surface or the object; or (ii) based at least on the visual property, at least one of an identity of or a physical property of the food preparation surface or the object;
determine a time attribute associated with at least one of the food preparation surface or the object; and
based on the determining, initiate at least one of:
progressing to a presentation of an existing instructional recipe step at a user output device based on at least one of the determined temperature, identity, or physical property of the food preparation surface or of the object, and further based on the determined time attribute; or
generating a new instructional recipe step, the new instructional recipe step being based on at least one of the determined temperature, identity, or physical property of the food preparation surface or of the object, and further based on the determined time attribute.

2. The computer system of claim 1, wherein the computer system includes,
a user interface (UI) computing device comprising the user output device, a first processor of the one or more processors, and a first communications device; and
an accessory device comprising the sensory array, a second processor of the one or more processors, and a second communications device,
wherein the UI computing device and the accessory device communicate via the first communications device and the second communications device.

3. The computer system of claim 1, wherein the sensory array also comprises at least one of, the at least one thermal sensor, the at least one visible light sensor, a distancing sensor, a barometric sensor, a humidity sensor, a gas sensor, a radar sensor, or a microphone.

4. The computer system of claim 1, wherein at least one of the one or more processors implement a machine learning (ML) engine, and wherein the ML engine performs the determining of at least one of the temperature, the identity, or the physical property of the object.

5. The computer system of claim 1, wherein the computer system initiates the progressing to the presentation of the existing instructional recipe step at the user output device, and wherein presenting the existing instructional recipe step at the user output device comprises presenting a user interface at a display device, the user interface including at least one of an indication of a desired ingredient, an indication of a desired cooking temperature, an indication of a desired cooking time, or a video of a prior recording of implementation of the instructional recipe step.

6. The computer system of claim 1, wherein the computer system initiates the generating the new instructional recipe step, and wherein generating the new instructional recipe step comprises generating at least one of, a time component, a temperature component, an ingredient component, an ingredient preparation component, or a video component.

7. The computer system of claim 1, wherein the computer-executable instructions include instructions that, when executed by at least one of the one or more processors, cause the computer system to transition from a lower power state to a higher power state based at least on having determined at least one of the temperature, the identity, or the physical property of the object.

8. The computer system of claim 1, wherein the physical property of the object comprises at least one of a color of the object, a size of the object, or a thickness of the object.

9. The computer system of claim 1, wherein the computer-executable instructions include instructions that, when executed by at least one of the one or more processors, cause the computer system to use the sensory array to determine a distance between the sensory array and the food preparation surface.

10. The computer system of claim 1, wherein the computer-executable instructions include instructions that, when executed by at least one of the one or more processors, cause the computer system to use the sensory array to determine at least one of a physical size or a thermal property of a cookware item positioned on the food preparation surface.

11. A method, implemented at a computer system that includes one or more processors and a user output device, for providing interactive cooking experiences, the method comprising:
determining, based on communicating with an accessory device, at least one of a temperature, an identity, or a physical property of a food preparation surface or of an object on the food preparation surface, the determined temperature, identity, or physical property of the food preparation surface or of the object being determined based at least on sensor data collected by the accessory device that is associated with at least one of, (i) a thermal property of at least one of the food preparation surface or the object as observed by at least one thermal sensor, or (ii) a visual property of at least one of the food preparation surface or the object as observed by at least one visible light sensor;
determine a time attribute associated with at least one of the food preparation surface or the object; and
based on the determining, performing at least one of:
progressing to a presentation of an existing instructional recipe step at a user output device based on at least one of the determined temperature, identity, or physical property of the food preparation surface or of the object; or
generating a new instructional recipe step, the new instructional recipe step being based on at least one of the determined temperature, identity, or physical property of the food preparation surface or of the object, and further based on the determined time attribute.

12. The method of claim 11, wherein, the computer system receives the existing instructional recipe step from a network-accessible interactive cooking assistance service as part of a recipe that includes a plurality of instructional recipe steps.

13. The method of claim 11, wherein, the computer system sends the new instructional recipe step to a network-accessible cooking assistance service as part of a recipe that includes a plurality of instructional recipe steps.

14. The method of claim 11, wherein the method comprises the progressing to the presentation of the existing instructional recipe step at the user output device, and wherein presenting the existing instructional recipe step at the user output device comprises presenting a user interface at a display device.

15. The method of claim 11, wherein the method comprises the generating the new instructional recipe step.

16. The method of claim 11, further comprising presenting a user interface that includes at least one of:
a dashboard interface that enables selection of a desired recipe;
an instruction panel that presents a plurality of recipe steps;
an ingredient panel that presents a plurality of recipe ingredients;
a recording UI control that enables recording of a live food preparation session;
a heatmap control that enables overlay over a temperature heatmap over the food preparation surface;
a temperature pin that presents at least a temperature at a location associated with the food preparation surface;
a temperature graph that presents at least one of historical cookware temperature observed by the accessory device, or goal cookware temperature obtained from a recipe; or
a sharing control that enables publishing of at least one of a recipe generated during a live food preparation session, a video recording of the live food preparation session, or a highlight reel of the live food preparation session.

17. A food preparation surface accessory device for providing interactive cooking experiences, comprising:
one or more processors;
one or more communication devices;
a sensory array; and
one or more hardware storage devices storing computer-executable instructions that, when executed by at least one of the one or more processors, cause the accessory device to at least:
collect, using the sensory array, sensor data associated with at least one of, (i) a thermal property of at least one of a food preparation surface or an object on the food preparation surface as observed by at least one thermal sensor, or (ii) a visual property of at least one of the food preparation surface or the object as observed by at least one visible light sensor;
determine, based on the collected sensor data, at least one of, (i) based at least on the thermal property, a temperature of at least one of the food preparation surface or the object; or (ii) based at least on the visual property, at least one of an identity of or a physical property of at least one of the food preparation surface or the object; and
send, using the one or more communication devices, at least one of the determined temperature, identity, or physical property of the food preparation surface or of the object to at least one of a network-accessible interactive cooking assistance service or a user interface (UI) computing device.

18. The food preparation surface accessory device of claim 17, wherein sending the at least one of the determined temperature, identity, or physical property of the food preparation surface or of the object to at least one of the network-accessible interactive cooking assistance service or the UI computing device, that initiates the UI computing device to perform at least one of:
determine a time attribute associated with at least one of the food preparation surface or the object;
progressing to a presentation of an existing instructional recipe step at a user output device based on at least one of the determined temperature, identity, or physical property of the food preparation surface or of the object, and further based on the determined time attribute; or
generating a new instructional recipe step, the new instructional recipe step being based on at least one of the determined temperature, identity, or physical property of the food preparation surface or of the object, and further based on the determined time attribute.

19. The food preparation surface accessory device of claim 17, wherein the sensory array also comprises at least one of, the at least one thermal sensor, the at least one visible light sensor, a distancing sensor, a barometric sensor, a humidity sensor, a gas sensor, a radar sensor, or a microphone.

20. The food preparation surface accessory device of claim 17, wherein at least one of the one or more processors implement a machine learning (ML) engine, and wherein the ML engine performs the determining of at least one of the temperature, the identity, or the physical property of the object.
